(19) United States
(12) Patent Application Publication
(10) Pub. No.: US 2009/0234658 A1
(43) Pub. Date: Sep. 17, 2009

(54) INTELLIGENT CAR POOLING PORTAL

(75) Inventors: John C. Greenwell, (US); Doug Wilson, (US)

Correspondence Address: LAW OFFICES OF EUGENE M. CUMMINGS, P.C., ONE NORTH WACKER DRIVE, SUITE 4130, CHICAGO, IL, 60606, US

(73) Assignee: Continental Electrical Construction Company, LLC

(21) Appl. No.: 12/046,158

(22) Filed: Mar. 11, 2008

(51) Int. Cl. G06Q 99/00

(52) U.S. Cl. 705/1

(57) ABSTRACT

A car pool software package is disclosed. The software suggests potential car pool partners by scanning a database of commuters, such as an employee database, as well as a facility database to determine arrival and departure times. An ordered list of potential car pool partners is then generated and forwarded to interested commuters. Pollution savings may be calculated and reported to an appropriate agency in exchange for credits to offset other pollution or trade on the open market.

### FIELD OF THE INVENTION

The present invention relates generally to systems, apparatus, and methods for facilitating car pooling arrangements, and more specifically to systems, apparatus, and methods for facilitating car pooling arrangements between people frequently seeking a common destination, such as workers sharing a common building or tenants of a common parking garage.

### DESCRIPTION OF THE PRIOR ART

Car pooling is a well known method for drivers to cut expenses and promote environmental responsibility, without giving up many of the benefits of driving. For example, departure schedules can be negotiated with other car pool participants, as opposed to being constrained to fixed bus or train schedules. However, despite the economic, environmental, and social benefits to car pooling, it is still far from a popular mode of transportation.

There are a number of barriers to the widespread adoption of car pools. First and foremost, the financial benefits, meaning savings from lowered fuel expenditures, parking fees, automobile maintenance, etc., are presently not sufficient for most people to offset the decrease in personal freedom that comes from driving one's own vehicle. However, with gas prices rising rapidly, and the corresponding shift from larger, more comfortable vehicles to smaller, less comfortable, but more fuel efficient vehicles, at least some segment of the population is likely to find car pools more attractive.

Second, car pooling is difficult for many people, because they do not know one or more reliable car pool partners. The prior art contains several attempted solutions at this problem. For example, U.S. Pat. No. 7,062,376, issued to Christopher Oesterling, discloses a system for reliably tracking the locations that particular drivers travel on their daily routes, and using this information, along with user's preferences, e.g., smoking or non-smoking, to better suggest potential car pool partners.

Other systems, such as that disclosed by U.S. Pat. No. 5,604,676, essentially disclose a “bus” personalized to the preferences of a limited number of persons.

Third, people are less likely to want to share their commute with others that they are not familiar with. For example, human nature suggests that a person is more likely to be willing to car pool with a friend, coworker, or neighbor, than with a stranger.

Fourth, and finally, while certain market players, such as employers, are well-situated to expedite the adoption of car pooling by commuters, there is presently no incentive for them to do so, aside from the positive press that they may receive as a result of setting up a car pool.

### OBJECTS OF THE INVENTION

Accordingly, it is an object of this invention to provide a system, apparatus, and method for using databases of information about persons sharing a known destination to offer better opportunities for car pooling.

Another object of this invention is to provide a system, apparatus, and method for using an employers human resources database, parking spot database, facility database, and/or other databases to offer better opportunities for car pooling.

Another object of this invention is to provide a system, apparatus, and method for providing an employer or other market participant a financial incentive to organize car pools.

### SUMMARY OF THE INVENTION

The disclosed invention achieves its objectives by providing car pool software that accesses a commuter database and a facility database, and uses the information in both to provide potential car pool partners for a car pool application. In one embodiment of the disclosed invention, an employer facilitates car pooling among employees by deploying a server with car pool software installed. The server receives communications from employees seeking to participate in a car pool with their fellow employees. The car pool software then accesses an employee database and retrieves records containing the address of employees looking for car pool partners. The car pool software then generates a list of potential car pool partners based on how close the employees live to one another. These lists are communicated to employees seeking car pool partners, who can use contact information contained in the list to arrange car pools.

In another embodiment of the disclosed invention, the car pool software also accesses a facility database and determines when different potential car poolers arrive and leave a destination facility. The generated list of potential car pool partners is then also ranked by how close the arrival and departure times of potential car pool partners are.

In a further refinement of the disclosed invention, pollution savings, such as carbon emissions, can be tracked and turned into pollution credits to be traded on an appropriate market. To accurately track this information, individual commuters are associated with their respective car pools, and specific savings are calculated from the types of vehicle used by the car poolers, as well as by the driver. Participation in the car pool is also monitored and total pollution savings are accumulated and reported to an appropriate agency in exchange for pollution credits, such as carbon credits.

### BRIEF DESCRIPTION OF THE DRAWINGS

Although the characteristic features of this invention will be particularly pointed out in the claims, the invention itself, and the manner in which it may be made and used, may be better understood by referring to the following description taken in connection with the accompanying drawings forming a part hereof, wherein like reference numerals refer to like parts throughout the several views and in which:

FIG. 1 is a network diagram of a computer information system constructed in accordance with an embodiment of the disclosed invention;

FIG. 2 is an entity relationship diagram describing a software system constructed in accordance with an embodiment of the disclosed invention;

FIG. 3 is a data flow diagram illustrating the basic operation of a software system constructed in accordance with an embodiment of the disclosed invention;

FIG. 4 is a flow chart illustrating a method for tracking pollution savings in accordance with an embodiment of the disclosed invention.

### DETAILED DESCRIPTION OF THE ILLUSTRATED EMBODIMENT

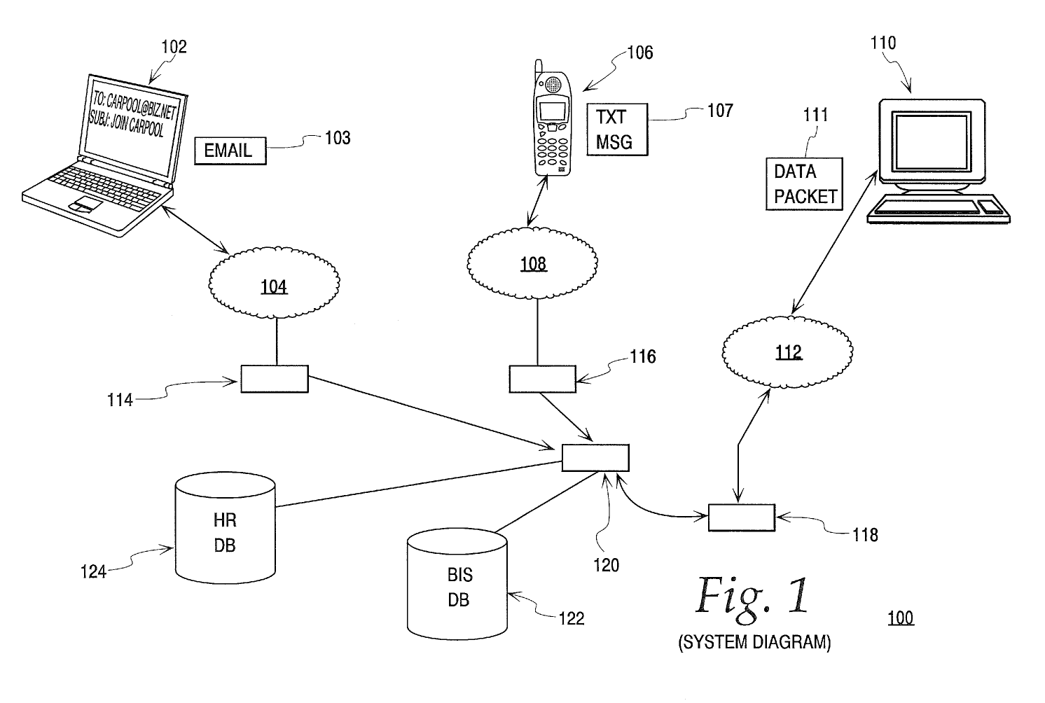

Turning to the Figures, and to FIG. 1 in particular, a computer information system implementing a car pool matching application is depicted. As explained herein, the disclosed invention allows an operator of a destination facility to suggest potential car pool matches to commuters sharing the facility as a destination. For example, using the disclosed invention, employers can suggest potential car pool matches to employees who work at the same office. Similarly, a parking garage operator could use the disclosed invention to suggest potential car pool matches to users of the facility.

A user (not shown) uses an electronic communication means to express interest in an organized car pool. As shown, the user could (1) send an email 103 using a computer 102, (2) send a text message 107 using a cell phone 106, or (3) generate a data packet 111 through the use of a web page on a personal computer 110. The particular medium or device used by the user is not a limitation of the invention. For instance, a user leaving a voice message at a particular call in number, accessing a web page using a cell phone, or sending a text message with a personal computer all would fall within the scope of the invention. The user's communication, e.g., 103,107,111, is then routed through an appropriate network. An email 103 could be routed through an email provider's network and the Internet 104, or could also be routed entirely through a private network (not shown). A text message 107 could be routed through a wireless provider's telephony network 108, or could be routed through the Internet. A data packet 111 could be routed through a private network 112, or could be routed through the Internet. Servers 114,116,118 handle requests from the network they are coupled to and route those requests to car pool server 120. Note that servers 114,116,118 could be combined into a single server adapted to handle all networks used by the car pooling application, and could be further combined with car pool server 120 without violating the spirit of the invention.

The car pool server 120 then accesses a human resources (“HR”) database 124, or other database containing information about users of a facility, associates the requester (not shown) with a record stored in the database, and extracts the requester's address. In addition, the car pool server 120 will access a building-information-systems (“BIS”) database 122 to determine when the requester arrives and/or leaves the destination facility. For example, if the implemented system is implemented by an employer, the BIS database could track when an employee swipes into a facility with a key card in the morning, and when the employee swipes out in the afternoon or evening. Alternatively, a system implemented by a parking garage could access a commuter's radio access system records, assuming the parking garage uses a radio system for access, to determine when a user's vehicle has entered the garage in the morning, and when the user's vehicle leaves in the afternoon or evening.

Once the car pool server 120 has determined the requester's address and arrival and departure times, it will access the HR database 124 and BIS database 122 to search for suitable car pool partners. Only other commuters that have elected to take part in the car pool program will be examined, although other suitable car pool partners may be flagged, and notified that, if they desire to participate in a car pool, suitable partners exist. Resulting commuters will be ranked according to how close they live to the requesting commuter and how similar their arrival and departure times are. Results will then be communicated back to the requesting commuter via any suitable message, such as email 103, text message 107, or data packet 111.

In a further refinement, the requesting commuter could indicate preferences for car pool partners, which would then be matched against other car pool participant's preferences to better suggest potential car pool partners. Some possible preferences include, without limitation, sex (male, female, or no preference), religion (Jewish, Christian, Muslim, Hindu, non religious, etc.), smoking (smoker, non-smoker, or no preference), political persuasion (Democrat, Republican, non-partisan, etc.), and general interests (sports, theater, hiking, etc.).

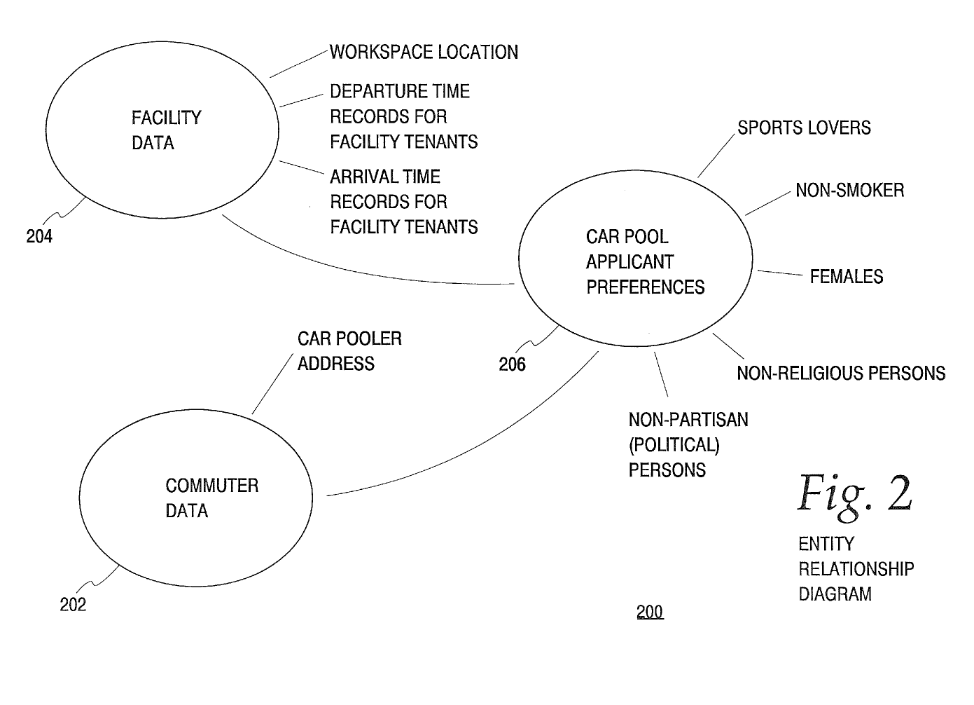

FIG. 2 depicts one possible relationship between data sources used in implementing the disclosed invention. A commuter database 202 holds information about commuters, at least some of which participate in a car pool program. The commuter database 202 should hold at least the address of commuters. A facility database 204 holds information about a destination facility (not shown), including at least arrival time records and departure time records for commuters using the facility. In addition, a car pool applicant preferences data source 206 stores optional preferences expressed by commuters participating in a car pool program. Note that the car pool applicant preferences data source 206 could be implemented in a separate database or combined with the commuter database 202.

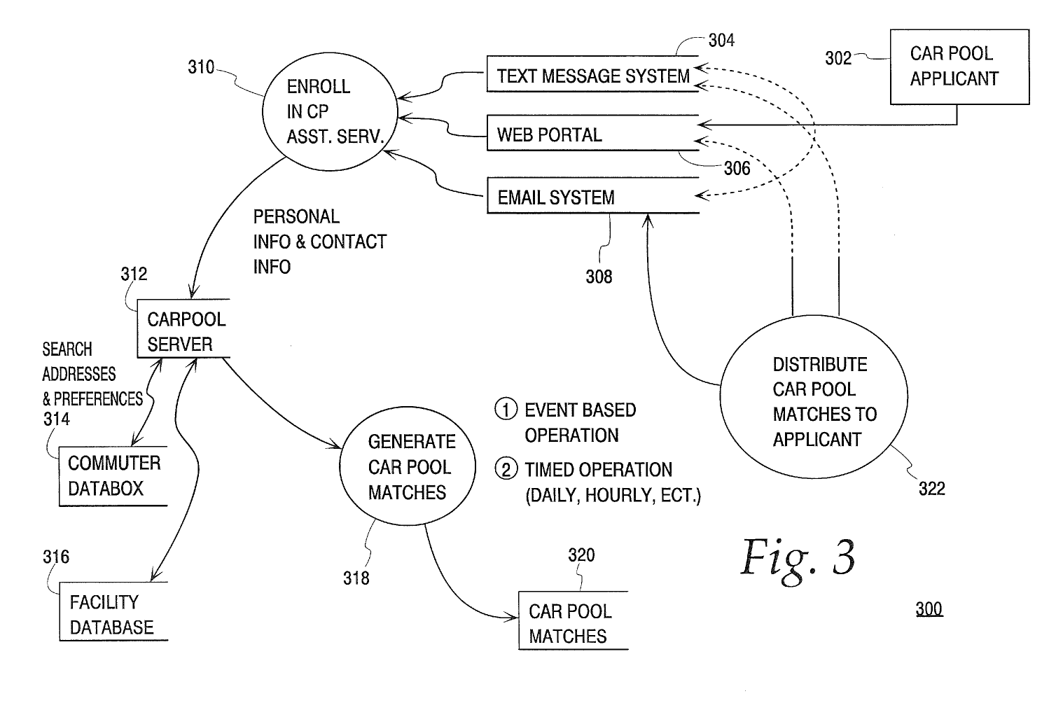

FIG. 3 depicts a data flow diagram illustrating the basic operation of the disclosed car pooling application. A car pool applicant 302 initiates contact with the car pool application through a suitable medium, such as a text message system 304, a web portal 306, or an email system 308. To enroll in the sponsored car pool assistance service in step 310, the car pool applicant's preferences and contact information is forwarded to a car pool server 312. If preferences are input by the car pool applicant 302, they could be stored in a separate preferences database (not shown) or in the commuter database 314, along with other information about the commuter, such as the commuter's home address. The car pool server 312 searches the commuter database 314 for a record matching the car pool applicant 302 to determine the car pool applicant's 302 home address. In addition, the car pool server 312 searches the facility database 316 to identify when the car pool applicant 302 generally arrives at and departs a destination facility (not shown).

The car pool server 312 uses information about the car pool applicant 302 to find potential car pool partners. The commuter database 314 and the facility database 316 are searched for potential car pool partners with home addresses and arrival/departure times similar to that of the car pool applicant 302. Algorithms well-known in the prior art can then generate an ordered list of potential car pool partners in step 318. For example, latitude longitude coordinates for home addresses can be compared to generate straight line distances in kilometers between the car pool applicant's 302 home and that of potential partners. Differences in average arrival and departure time in minutes can then be added to the distance in kilometers, and the resultant quantities sorted in ascending order, i.e., with the lowest quantities ranked highest. Potential partners above some threshold could be excluded entirely. The generation of potential car pool partners could be event based, i.e., a list of potential partners would be generated whenever a communication from a new car pool applicant 302 was received, or a list of potential partners could be generated periodically, such as one time per day.

Once an ordered list of car pool partners 320 has been generated, that list is forwarded to the car pool applicant 302 in step 322. The list could be forwarded to the car pool applicant 302 using any suitable communication mechanism, such as a text message system 304, a web portal 306, or an email system 308.

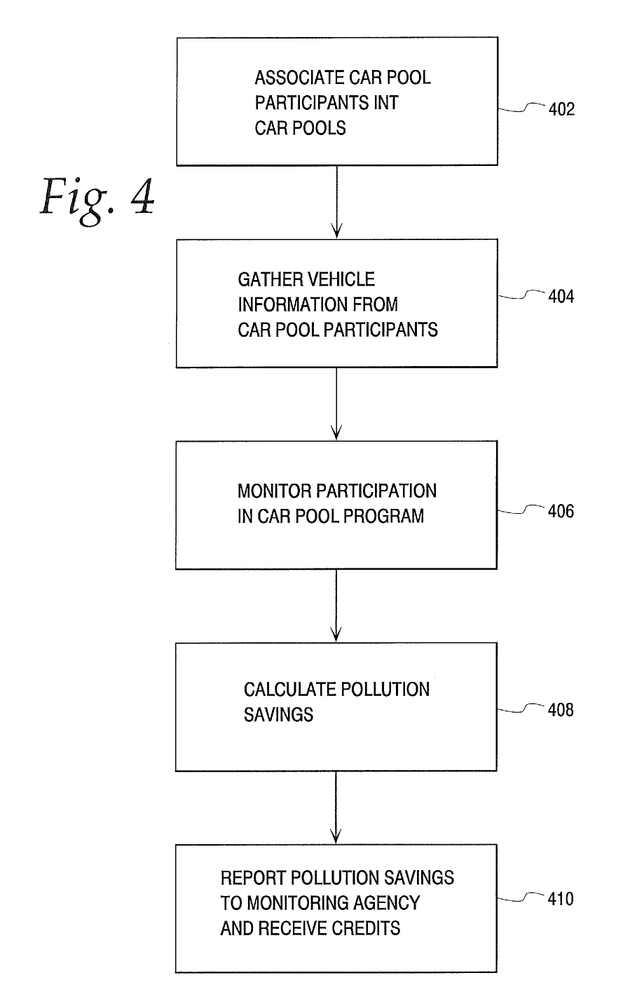

A further use of this invention allows a car pool organizer to calculate total pollution savings from a car pool program, for which the organizer would receive a credit, e.g., a carbon credit, or other type of pollution credit. The credit could then be used to allow for greater emissions, or, if not needed, could be sold on the open market. While no program presently exists to compensate businesses that organize car pools with pollution credits, the benefits of such a program to society are readily apparent. FIG. 4 illustrates one method that could be used to implement such a program.

In step 402 car pool partners are associated into car pools. This may be done by expanding the method of FIG. 3 to include tracking what car pool partners a particular applicant joins with to form a car pool. In step 404, the types of vehicle that each car pool participant typically drives is gathered, as well as the vehicle(s) that is typically used by the car pool. This information will be used to determine the actual amount of pollution savings by determining the total amount of pollutants that would have been emitted without the carpool, and subtracting the amount emitted by the car pool vehicle. Gathering vehicle information from commuters in this way may open such a system to fraudulent reporting, and therefore, step 404 could alternatively be skipped, and an average savings for each member of a car pool above and beyond the driver could be used.

In step 406, the actual participation of commuters in a car pool is monitored. This could be done on an honor system. For instance, a web page could be setup where commuters would indicate on a daily basis whether or not they participated in a car pool, or, alternatively, users could enter information at a kiosk on entering a facility whether or not they participated in a car pool. Participation could also be measured objectively. One way to do this would be to monitor the arrival and departure times of car pool participants. If their arrival and departure times are close to one another, such as within ten minutes, and they were car pool partners, then it would be assumed that they car pooled that day. This would require further modification of the car pool server 312 to appropriately monitor the facility database 316 and to make the necessary associations.

In step 408, pollution savings would be calculated based on the savings per car pool calculated in step 404 and the monitoring of car pool participation in step 406. This step could be performed periodically, such as every month. The savings would then be reported to an appropriate agency, and a pollution credit would be issued to the car pool organizer, such as an employer utilizing the invention disclosed herein.

The foregoing description of the invention has been presented for purposes of illustration and description, and is not intended to be exhaustive or to limit the invention to the precise form disclosed. The description was selected to best explain the principles of the invention and practical application of these principles to enable others skilled in the art to best utilize the invention in various embodiments and various modifications as are suited to the particular use contemplated. It is intended that the scope of the invention not be limited by the specification, but be defined by the claims set forth below.

What is claimed is:

1. A method operating on a computer system for an employer to suggest potential car pool partners to employees comprising the steps of:
i) receiving a communication from one of said employees seeking potential car pool partners;
ii) accessing an employee database associated with said employer and having a plurality of information records containing information describing a plurality of employees, said information records containing at least home addresses and contact information for at least some of said employees, wherein one or more of said plurality of information records is associated with one or more of said employees;
iii) associating said one employee with one or more employee database information records;
iv) searching said employee database and identifying one or more of said employees having a home address near the home address of said one employee; and
v) communicating contact information for at least some of said identified employees to said one employee.

2. The method of claim 1, further comprising the steps of:
i) accessing a facility database associated with a facility and having a plurality of information records containing at least information describing arrival and departure times for a plurality of employees, wherein one or more of said plurality of information records is associated with one or more of said employees;
ii) associating said one employee with one or more facility database information records; and
iii) searching said facility database and identifying one or more employees having arrival and departure times near the arrival and departure times of said one employee.

3. The method of claim 1, wherein said receiving step comprises receiving (a) a text message communication, (b) an email, or (c) information entered into a web page.

4. The method of claim 1, wherein said communicating step comprises communicating contact information to said prospective car pooler by the same communication format by which said communication from said prospective car pooler was received.

5. The method of claim 1 further comprising the steps of:
i) tracking each employee participating in a car pool, and assigning a carbon savings to each of said car pools; and
ii) generating a total carbon savings.

6. A method operating on a computer system for the operator of a destination facility to suggest potential car pool partners to driving commuters sharing said destination facility, said method comprising the steps of:
i) receiving a communication from one of said driving commuters seeking potential car pool partners;
ii) accessing a commuter database associated with said operator and having a plurality of information records containing information describing a plurality of driving commuters, said information records containing at least home addresses and contact information for at least some of said driving commuters, wherein one or more of said plurality of information records is associated with one or more of said driving commuters;
iii) associating said one driving commuter with one or more commuter database information records;
iv) searching said commuter database and identifying one or more of said driving commuters having a home address near the home address of said one driving commuter;
v) accessing a facility database associated with said destination facility having a plurality of information records containing at least information describing arrival and departure times for a plurality of commuters, wherein one or more of said plurality of information records is associated with one or more of said commuters;
vi) associating said one commuter with one or more facility database information records;
vii) searching said facility database and identifying one or more commuters having arrival and departure times near the arrival and departure times of said one commuter;
viii) generating an ordered list of commuters having home addresses near the home address of said one commuter and arrival and departure times near the arrival and departure times of said one commuter; and
ix) communicating contact information for at least some of said commuters on said ordered list to said one commuter.
